(19) United States
(12) Patent Application Publication
(10) Pub. No.: US 2013/0188741 A1
(43) Pub. Date: Jul. 25, 2013

(54) DEVICES AND METHODS FOR SAMPLE ADAPTIVE OFFSET CODING AND/OR SELECTION OF BAND OFFSET PARAMETERS

(71) Applicant: General Instrument Corporation, Horsham, PA (US)

(72) Inventors: Koohyar Minoo, San Diego, CA (US); David Baylon, San Diego, CA (US); Yue Yu, San Diego, CA (US); Limin Wang, San Diego, CA (US)

(73) Assignee: GENERAL INSTRUMENT CORPORATION, Horsham, PA (US)

(21) Appl. No.: 13/734,765

(22) Filed: Jan. 4, 2013

Related U.S. Application Data
(60) Provisional application No. 61/589,298, filed on Jan. 21, 2012.
(60) Provisional application No. 61/597,041, filed on Feb. 9, 2012.
(60) Provisional application No. 61/619,916, filed on Apr. 3, 2012.

(51) Int. Cl. H04N 7/26

(52) U.S. Cl. CPC H04N 19/00903
USPC 375/240.26

(57) ABSTRACT

In one embodiment, a method for encoding sample adaptive offset (SAO) values in a video encoding process is provided, the method comprising: selecting a band offset type; determining a range of values associated with the selected band offset type, the range of values not being transmitted during encoding; generating one or more offset values for the selected band offset type; and optionally applying an offset value to at least a current pixel value to form an SAO compensated value.

### CROSS-REFERENCE TO RELATED APPLICATIONS

The present application claims the benefit of U.S. provisional patent application No. 61/589,298, entitled “Modified SAO Band Offset Type and Classes” filed Jan. 21, 2012, U.S. provisional patent application No. 61/597,041, entitled “Modifications to SAO Band Offset and Edge Offset” filed Feb. 9, 2012, U.S. provisional patent application No. 61/616,373, entitled “Modifications to SAO Band Offset” filed Mar. 27, 2012, and U.S. provisional patent application No. 61/619,916, entitled “Modifications to SAO Band Offset” filed Apr. 3, 2012, which are incorporated herein by reference in their entirety.

### FIELD

The disclosure relates generally to the field of video coding, and more specifically to systems, devices and methods for sample adaptive offset (SAO) coding and/or selection of band offset (BO) parameters.

### BACKGROUND

Video compression uses block processing for many operations. In block processing, a block of neighboring pixels is grouped into a coding unit and compression operations treat this group of pixels as one unit to take advantage of correlations among neighboring pixels within the coding unit. Block-based processing often includes prediction coding and transform coding. Transform coding with quantization is a type of data compression which is commonly “lossy” as the quantization of a transform block taken from a source picture often discards data associated with the transform block in the source picture, thereby lowering its bandwidth requirement but often also resulting in quality loss in reproducing of the original transform block from the source picture.

MPEG-4 AVC, also known as H.264, is an established video compression standard that uses transform coding in block processing. In H.264, a picture is divided into macroblocks (MBs) of 16×16 pixels. Each MB is often further divided into smaller blocks. Blocks equal in size to or smaller than a MB are predicted using intra-/inter-picture prediction, and a spatial transform along with quantization is applied to the prediction residuals. The quantized transform coefficients of the residuals are commonly encoded using entropy coding methods (e.g., variable length coding or arithmetic coding). Context Adaptive Binary Arithmetic Coding (CABAC) was introduced in H.264 to provide a substantially lossless compression efficiency by combining an adaptive binary arithmetic coding technique with a set of context models. Context model selection plays a role in CABAC in providing a degree of adaptation and redundancy reduction. H.264 specifies two kinds of scan patterns over 2D blocks. A zigzag scan is used for pictures coded with progressive video compression techniques and an alternative scan is for pictures coded with interlaced video compression techniques.

HEVC (High Efficiency Video Coding), an international video coding standard developed to succeed H.264, extends transform block sizes to 16×16 and 32×32 pixels to benefit high definition (HD) video coding.

### BRIEF DESCRIPTION OF THE DRAWINGS

The details of the present disclosure, both as to its structure and operation, may be understood in part by study of the accompanying drawings, in which like reference numerals refer to like parts. The drawings are not necessarily to scale, emphasis instead being placed upon illustrating the principles of the disclosure.

FIG. 1A is a video system in which the various embodiments of the disclosure may be used;

FIG. 1B is a computer system on which embodiments of the disclosure may be implemented;

FIGS. 2A, 2B, 3A and 3B illustrate certain video encoding principles according to embodiments of the disclosure;

FIGS. 4A and 4B show possible architectures for an encoder and a decoder according to embodiments of the disclosure;

FIGS. 5A and 5B illustrate further video coding principles according to an embodiments of the disclosure;

FIG. 6 illustrates an example band offset specification according to embodiments of the disclosure;

FIG. 7 illustrates an example band offset specification having a distribution of values according to embodiments of the disclosure;

FIG. 8 illustrates an example band offset specification according to embodiments of the disclosure;

FIG. 9 illustrates an example architecture for coding of offsets according to embodiments of the disclosure;

FIG. 10 illustrates an example band offset specification according to embodiments of the disclosure.

### BRIEF SUMMARY

Accordingly, there is provided herein systems and methods that improve video quality by selection, coding, and signaling of parameters in a sample adaptive offset (SAO) process. The methods and systems described herein generally pertain to video processing such as video encoders and decoders.

In a first aspect, a method for encoding sample adaptive offset (SAO) values in a video encoding process is provided, the method comprising: selecting a band offset type; determining a range of values associated with the selected band offset type, the range of values not being transmitted during encoding; generating one or more offset values for the selected band offset type; and optionally applying an offset value to at least a current pixel value to form an SAO compensated value. In an embodiment of the first aspect, the range of values is determined based on a subset of pixel values in a unit. In an embodiment of the first aspect, the subset of pixels in a unit is selected from the group consisting of: alternating samples, single quarter pixel samples, and corner and center samples of the unit. In an embodiment of the first aspect, the band offset type is defined by the determined range of values. In an embodiment of the first aspect, the range of values is specified by a start value and an end value. In an embodiment of the first aspect, the range of values is partitioned into a number of sub-classes. In an embodiment of the first aspect, the range of values is partitioned uniformly into a number of sub-classes, each sub-class having an equal width. In an embodiment of the first aspect, the range of values determined by the video coding system is based in part on data in a video block.

In an embodiment of the first aspect, the range of values is based in part on rate-distortion considerations. In an embodiment of the first aspect, the range of values is determined from a maximum value and a minimum value derived from data in the video block. In an embodiment of the first aspect, the range of values is a statistical distribution of values within the range determined from the minimum value and maximum value. In an embodiment of the first aspect, the minimum value and maximum value is derived from a function or transformation of data in the video block. In an embodiment of the first aspect, the minimum value and maximum value is derived from the mean value of data in the video block. In an embodiment of the first aspect, the method further comprises: determining one or more sub-classes for at least one band offset type, wherein the number of sub-classes are specified relative to the mean value. In an embodiment of the first aspect, the one or more sub-classes are centered or shifted about the mean value. In an embodiment of the first aspect, the band offset type includes a portion of the band defined by the range of values and a portion of the band on either edge of the range of values, wherein the offset value is applied to all portions of the band. In an embodiment of the first aspect, the range of values is specified by a start value and an end value and wherein the offset value applied to the band that is proximate to the start value, but not included in the range of values, is the same offset applied to the range of values at the start value. In an embodiment of the first aspect, the range of values is specified by a start value and an end value and wherein the offset value applied to the band that is proximate to the end value, but not included in the range of values, is the same offset applied to the range of values at the end value. In an embodiment of the first aspect, the method further comprises: partitioning video data into blocks, wherein each of the blocks is equal to or smaller than a picture; applying SAO compensation to each of the pixels in a processed video block. In an embodiment of the first aspect, the method is implemented on a computer having a processor and a memory coupled to said processor, wherein at least some of steps are performed using said processor.

In a second aspect, an apparatus configured to encode sample adaptive offset (SAO) values in a video coding process is provided, the apparatus comprising: a video encoder configured to: partition video data into blocks, wherein each of the blocks is equal to or smaller than a picture; select a band offset type; determine a range of values associated with the selected band offset type, the range of values not being transmitted during encoding; generate one or more offset values for the selected band offset type; and apply the offset value to at least a current pixel value to form an SAO compensated value.

In a third aspect, a method for decoding sample adaptive offset (SAO) values in a video decoding process is provided, the method comprising: (a) obtaining processed video data from a video bitstream; (b) partitioning the processed video data into blocks, wherein each of the blocks is equal to or smaller than a picture; (c) deriving an SAO type from the video bitstream for each of the blocks, wherein the SAO type is selected from the group consisting of one or more edge offset (EO) types and one or more band offset (BO) types; (d) determining an SAO sub-class associated with the BO type, wherein the sub-class is defined by a range of values that is derived from the processed video data, wherein the range of values is not transmitted to the decoding process; (e) deriving intensity offset from the video bitstream for the sub-class associated with the SAO type; and (f) applying SAO compensation to each of the pixels in a processed video block, wherein the SAO compensation is based on the intensity offset of step (e). In an embodiment of the third aspect, the range of values is determined from a maximum value and a minimum value derived from data in the video block. In an embodiment of the third aspect, the range of values is a statistical distribution of values within the range determined from the minimum value and maximum value. In an embodiment of the third aspect, the minimum value and maximum value is derived from a function or transformation of data in the video block. In an embodiment of the third aspect, the minimum value and maximum value is derived from the mean value of data in the video block. In an embodiment of the third aspect, the band offset type includes a portion of a band defined by the range of values and a portion of the band on either edge of the range of values, wherein the intensity offset is applied to all portions of the band. In an embodiment of the third aspect, the range of values is specified by a start value and an end value and wherein the intensity offset is applied to the band that is proximate to the start value, but not included in the range of values, is the same offset applied to the range of values at the start value. In an embodiment of the third aspect, wherein the range of values is specified by a start value and an end value and wherein the intensity offset applied to the band that is proximate to the end value, but not included in the range of values, is the same offset applied to the range of values at the end value. In an embodiment of the third aspect, the method is implemented on a computer having a processor and a memory coupled to said processor, wherein at least some of steps (a) through (f) are performed using said processor.

In a fourth aspect, an apparatus configured to decode sample adaptive offset (SAO) values in a video decoding process is provided, the apparatus comprising: a video decoder configured to: partition video data into blocks, wherein each of the blocks is equal to or smaller than a picture; derive an SAO type from the video bitstream for each of the blocks, wherein the SAO type is selected from the group consisting of one or more edge offset (EO) types and one or more band offset (BO) types; determine an SAO sub-class associated with the BO type; derive intensity offset from the video bitstream for the sub-class associated with the BO type, wherein the sub-class is defined by a range of values that is derived from the processed video data, wherein the range of values is not transmitted to the decoding process; and apply SAO compensation to each of the pixels in a processed video block, wherein the SAO compensation is based on the intensity offset. In an embodiment of the fourth aspect, the apparatus comprises at least one of: an integrated circuit; a microprocessor; and a wireless communication device that includes the video decoder.

### DETAILED DESCRIPTION

In this disclosure, the term “coding” refers to encoding that occurs at the encoder or decoding that occurs at the decoder. Similarly, the term coder refers to an encoder, a decoder, or a combined encoder/decoder (CODEC). The terms coder, encoder, decoder and CODEC all refer to specific machines designed for the coding (encoding and/or decoding) of video data consistent with this disclosure.

The present discussion begins with a very brief overview of some terms and techniques known in the art of digital image compression. This overview is not meant to teach the known art in any detail. Those skilled in the art know how to find greater details in textbooks and in the relevant standards.

An example of a video system in which an embodiment of the disclosure may be used will now be described. It is understood that elements depicted as function blocks in the figures may be implemented as hardware, software, or a combination thereof. Furthermore, embodiments of the disclosure may also be employed on other systems, such as on a personal computer, smartphone or tablet computer.

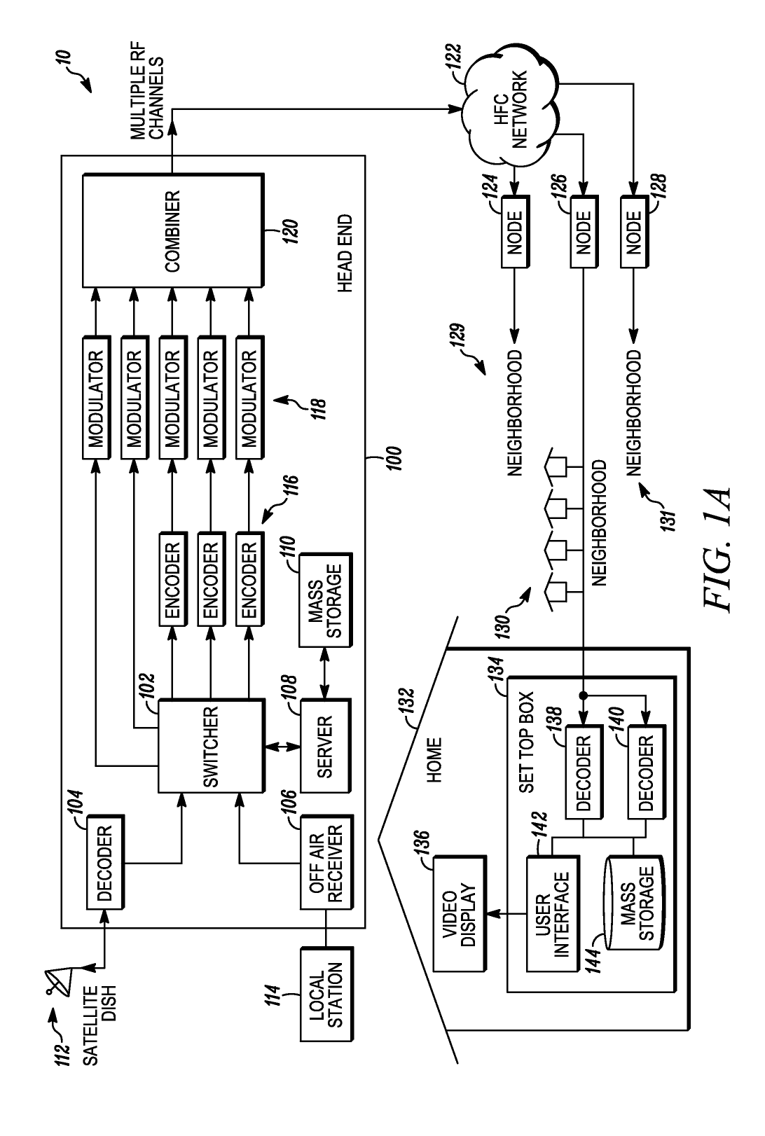

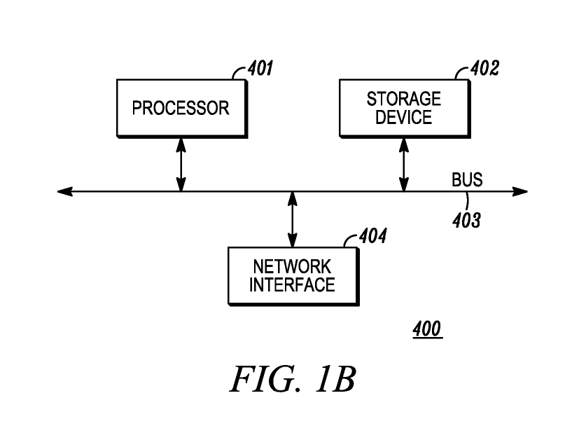

Referring to FIG. 1A, a video system, generally labeled 10, may include a head end 100 of a cable television network. The head end 100 may be configured to deliver video content to neighborhoods 129, 130 and 131. The head end 100 may operate within a hierarchy of head ends, with the head ends higher in the hierarchy generally having greater functionality. The head end 100 may be communicatively linked to a satellite dish 112 and receive video signals for non-local programming from it. The head end 100 may also be communicatively linked to a local station 114 that delivers local programming to the head end 100. The head end 100 may include a decoder 104 that decodes the video signals received from the satellite dish 112, an off-air receiver 106 that receives the local programming from the local station 114, a switcher 102 that routes data traffic among the various components of the head end 100, encoders 116 that encode video signals for delivery to customers, modulators 118 that modulate signals for delivery to customers, and a combiner 120 that combines the various signals into a single, multi-channel transmission.

The head end 100 may also be communicatively linked to a hybrid fiber cable (HFC) network 122. The HFC network 122 may be communicatively linked to a plurality of nodes 124, 126, and 128. Each of the nodes 124, 126, and 128 may be linked by coaxial cable to one of the neighborhoods 129, 130 and 131 and deliver cable television signals to that neighborhood. One of the neighborhoods 130 of FIG. 1A is shown in more detail. The neighborhood 130 may include a number of residences, including a home 132 shown in FIG. 1A. Within the home 132 may be a set-top box 134 communicatively linked to a video display 136. The set-top box 134 may include a first decoder 138 and a second decoder 140. The first and second decoders 138 and 140 may be communicatively linked to a user interface 142 and a mass storage device 144. The user interface 142 may be communicatively linked to the video display 136.

During operation, head end 100 may receive local and nonlocal programming video signals from the satellite dish 112 and the local station 114. The nonlocal programming video signals may be received in the form of a digital video stream, while the local programming video signals may be received as an analog video stream. In some embodiments, local programming may also be received as a digital video stream. The digital video stream may be decoded by the decoder 104 and sent to the switcher 102 in response to customer requests. The head end 100 may also include a server 108 communicatively linked to a mass storage device 110. The mass storage device 110 may store various types of video content, including video on demand (VOD), which the server 108 may retrieve and provide to the switcher 102. The switcher 102 may route local programming directly to the modulators 118, which modulate the local programming, and route the non-local programming (including any VOD) to the encoders 116. The encoders 116 may digitally encode the non-local programming. The encoded non-local programming may then be transmitted to the modulators 118. The combiner 120 may be configured to receive the modulated analog video data and the modulated digital video data, combine the video data and transmit it via multiple radio frequency (RF) channels to the HFC network 122.

The HFC network 122 may transmit the combined video data to the nodes 124, 126 and 128, which may retransmit the data to their respective neighborhoods 129, 130 and 131. The home 132 may receive this video data at the set-top box 134, more specifically at the first decoder 138 and the second decoder 140. The first and second decoders 138 and 140 may decode the digital portion of the video data and provide the decoded data to the user interface 142, which then may provide the decoded data to the video display 136.

The encoders 116 and the decoders 138 and 140 of FIG. 1A (as well as all of the other steps and functions described herein) may be implemented as computer code comprising computer readable instructions stored on a computer readable storage device, such as memory or another type of storage device. The computer code may be executed on a computer system by a processor, such as an application-specific integrated circuit (ASIC), or other type of circuit. For example, computer code for implementing the encoders 116 may be executed on a computer system (such as a server) residing in the headend 100. Computer code for the decoders 138 and 140, on the other hand, may be executed on the set-top box 134, which constitutes a type of computer system. The code may exist as software programs comprised of program instructions in source code, object code, executable code or other formats. It should be appreciated that the computer code for the various components shown in FIG. 1A may reside anywhere in system 10 or elsewhere (such as in a cloud network), that is determined to be desirable or advantageous. Furthermore, the computer code may be located in one or more components, provided the instructions may be effectively performed by the one or more components.

FIG. 1B shows an example of a computer system on which computer code for the encoders 116 and the decoders 138 and 140 may be executed. The computer system, generally labeled 400, includes a processor 401, or processing circuitry, that may implement or execute software instructions performing some or all of the methods, functions and other steps described herein. Commands and data from processor 401 may be communicated over a communication bus 403, for example. Computer system 400 may also include a computer readable storage device 402, such as random access memory (RAM), where the software and data for processor 401 may reside during runtime. Storage device 402 may also include non-volatile data storage. Computer system 400 may include a network interface 404 for connecting to a network. Other known electronic components may be added or substituted for the components depicted in the computer system 400. The computer system 400 may reside in the headend 100 and execute the encoders 116, and may also be embodied in the set-top box 134 to execute the decoders 138 and 140. Additionally, the computer system 400 may reside in places other than the headend 100 and the set-top box 134, and may be miniaturized so as to be integrated into a smartphone or tablet computer.

Video encoding systems achieve compression by removing redundancy in the video data, e.g., by removing those elements that can be discarded without adversely affecting reproduction fidelity. Because video signals take place in time and space, most video encoding systems exploit both temporal and spatial redundancy present in these signals. Typically, there is high temporal correlation between successive frames. This is also true in the spatial domain for pixels which are close to each other. Thus, high compression gains are achieved by carefully exploiting these spatio-temporal correlations.

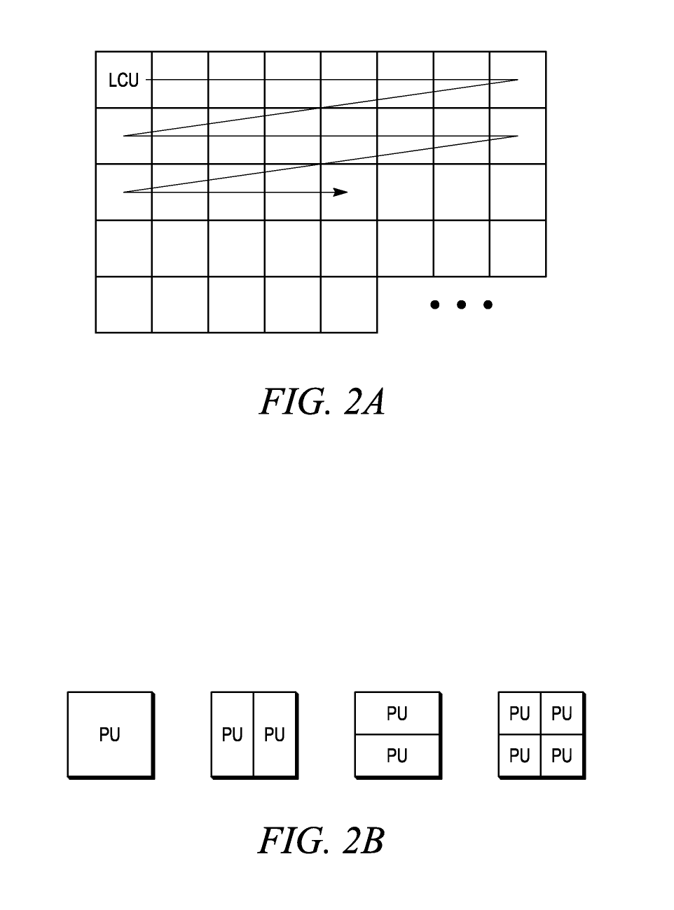

A high-level description of how video data gets encoded and decoded by the encoders 116 and the decoders 138 and 140 in an embodiment of the disclosure will now be provided. In this embodiment, the encoders and decoders operate according to a High Efficiency Video Coding (HEVC) method. HEVC is a block-based hybrid spatial and temporal predictive coding method. In HEVC, an input picture is first divided into square blocks, called LCUs (largest coding units) or CTUs (coding tree units), as shown in FIG. 2A. Unlike other video coding standards, in which the basic coding unit is a macroblock of 16×16 pixels, in HEVC, the LCU can be as large as 128×128 pixels. An LCU can be divided into four square blocks, called CUs (coding units), which are a quarter of the size of the LCU. Each CU can be further split into four smaller CUs, which are a quarter of the size of the original CU. The splitting process can be repeated until certain criteria are met. FIG. 3A shows an example of LCU partitioned into CUs.

How a particular LCU is split into CUs can be represented by a quadtree. At each node of the quadtree, a flag is set to “1” if the node is further split into sub-nodes. Otherwise, the flag is unset at “0.” For example, the LCU partition of FIG. 3A can be represented by the quadtree of FIG. 3B. These “split flags” may be jointly coded with other flags in the video bitstream, including a skip mode flag, a merge mode flag, and a predictive unit (PU) mode flag, and the like. In the case of the quadtree of FIG. 3B, the split flags 10100 could be coded as overhead along with the other flags. Syntax information for a given CU may be defined recursively, and may depend on whether the CU is split into sub-CUs.

A CU that is not split (e.g., a CU corresponding a terminal, or “leaf” node in a given quadtree) may include one or more prediction units (PUs). In general, a PU represents all or a portion of the corresponding CU, and includes data for retrieving a reference sample for the PU for purposes of performing prediction for the CU. Thus, at each leaf of a quadtree, a final CU of 2N×2N can possess one of four possible patterns (N×N, N×2N, 2N×N and 2N×2N), as shown in FIG. 2B. While shown for a 2N×2N CU, other PUs having different dimensions and corresponding patterns (e.g., square or rectangular) may be used. A CU can be either spatially or temporally predictive coded. If a CU is coded in intra mode, each PU of the CU can have its own spatial prediction direction. If a CU is coded in inter mode, each PU of the CU can have its own motion vector(s) and associated reference picture(s). The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the CU defining the one or more PUs of the CU may also describe, for example, partitioning of the CU into the one or more PUs. Partitioning modes may differ between whether the CU is uncoded, intra-prediction mode encoded, or inter-prediction mode encoded.

In general, in intra-prediction encoding, a high level of spatial correlation is present between neighboring blocks in a frame. Consequently, a block can be predicted from the nearby encoded and reconstructed blocks, giving rise to the intra prediction. In some embodiments, the prediction can be formed by a weighted average of the previously encoded samples, located above and to the left of the current block. The encoder may select the mode that minimizes the difference or cost between the original and the prediction and signals this selection in the control data.

In general, in inter-prediction encoding, video sequences have high temporal correlation between frames, enabling a block in the current frame to be accurately described by a region in the previous coded frames, which are known as reference frames. Inter-prediction utilizes previously encoded and reconstructed reference frames to develop a prediction using a block-based motion estimation and compensation technique.

Following intra-predictive or inter-predictive encoding to produce predictive data and residual data, and following any transforms (such as the 4×4 or 8×8 integer transform used in H.264/AVC or a discrete cosine transform (DCT)) to produce transform coefficients, quantization of transform coefficients may be performed. Quantization generally refers to a process in which transform coefficients are quantized to possibly reduce the amount of data used to represent the coefficients, e.g., by converting high precision transform coefficients into a finite number of possible values. These steps will be discussed in more detail below.

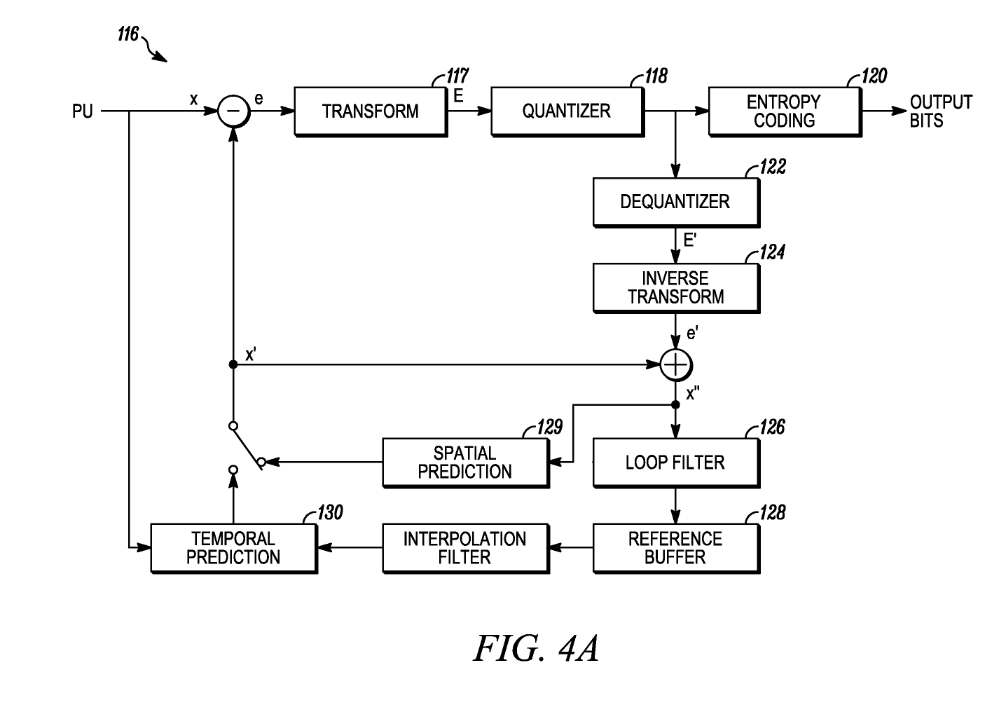

Each CU can also be divided into transform units (TUs) by application of a block transform operation. A block transform operation tends to decorrelate the pixels within the block and compact the block energy into the low order coefficients of the transform block. In some embodiments, one transform of 8×8 or 4×4 may be applied. In other embodiments, a set of block transforms of different sizes may be applied to a CU, as shown in FIG. 5A where the left block is a CU partitioned into PUs and the right block is the associated set of transform units (TUs). The size and location of each block transform within a CU is described by a separate quadtree, called RQT. FIG. 5B shows the quadtree representation of TUs for the CU in the example of FIG. 5A. In this example, 11000 is coded and transmitted as part of the overhead.

The TUs and PUs of any given CU may be used for different purposes. TUs are typically used for transformation, quantizing and coding operations, while PUs are typically used for spatial and temporal prediction. There is not necessarily a direct relationship between the number of PUs and the number of TUs for a given CU.

Video blocks may comprise blocks of pixel data in the pixel domain, or blocks of transform coefficients in the transform domain, e.g., following application of a transform, such as a discrete cosine transform (DCT), an integer transform, a wavelet transform, or a conceptually similar transform to residual data for a given video block, wherein the residual data represents pixel differences between video data for the block and predictive data generated for the block. In some cases, video blocks may comprise blocks of quantized transform coefficients in the transform domain, wherein, following application of a transform to residual data for a given video block, the resulting transform coefficients are also quantized. In video encoding, quantization is the step that introduces loss, so that a balance between bitrate and reconstruction quality can be established. These steps will be discussed further below.

Block partitioning serves an important purpose in block-based video coding techniques. Using smaller blocks to code video data may result in better prediction of the data for locations of a video frame that include high levels of detail, and may therefore reduce the resulting error (e.g., deviation of the prediction data from source video data), represented as residual data. In general, prediction exploits the spatial or temporal redundancy in a video sequence by modeling the correlation between sample blocks of various dimensions, such that only a small difference between the actual and the predicted signal needs to be encoded. A prediction for the current block is created from the samples which have already been encoded. While potentially reducing the residual data, such techniques may, however, require additional syntax information to indicate how the smaller blocks are partitioned relative to a video frame, and may result in an increased coded video bitrate. Accordingly, in some techniques, block partitioning may depend on balancing the desirable reduction in residual data against the resulting increase in bitrate of the coded video data due to the additional syntax information.

In general, blocks and the various partitions thereof (e.g., sub-blocks) may be considered video blocks. In addition, a slice may be considered to be a plurality of video blocks (e.g., macroblocks, or coding units), and/or sub-blocks (partitions of macroblocks, or sub-coding units). Each slice may be an independently decodable unit of a video frame. Alternatively, frames themselves may be decodable units, or other portions of a frame may be defined as decodable units. Furthermore, a GOP, also referred to as a group of pictures, may be defined as a decodable unit.

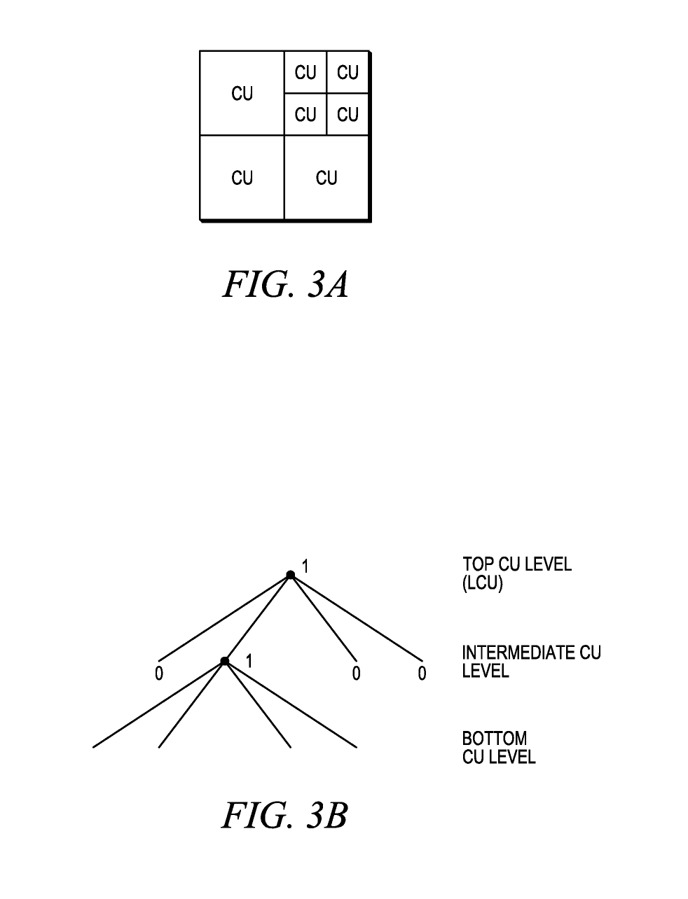

The encoders 116 (FIG. 1A) may be, according to an embodiment of the disclosure, composed of several functional modules as shown in FIG. 4A. These modules may be implemented as hardware, software, or any combination of the two. Given a current PU, x, a prediction PU, x′, may first be obtained through either spatial prediction or temporal prediction. This spatial or temporal prediction may be performed by a spatial prediction module 129 or a temporal prediction module 130 respectively.

There are several possible spatial prediction directions that the spatial prediction module 129 can perform per PU, including horizontal, vertical, 45-degree diagonal, 135-degree diagonal, DC, Planar, etc. Including the Luma intra modes, an additional mode, called IntraFromLuma, may be used for the Chroma intra prediction mode. A syntax indicates the spatial prediction direction per PU.

The encoder 116 (FIG. 1A) may perform temporal prediction through motion estimation operation. Specifically, the temporal prediction module 130 (FIG. 4A) may search for a best match prediction for the current PU over reference pictures. The best match prediction may be described by motion vector (MV) and associated reference picture (refIdx). Generally, a PU in B pictures can have up to two MVs. Both MV and refIdx may be part of the syntax in the bitstream.

The prediction PU may then be subtracted from the current PU, resulting in the residual PU, e. The residual PU, e, may then be transformed by a transform module 117, one transform unit (TU) at a time, resulting in the residual PU in the transform domain, E. To accomplish this task, the transform module 117 may use e.g., either a square or a non-square block transform.

Referring back to FIG. 4A, the transform coefficients E, may then be quantized by a quantizer module 118, converting the high precision transform coefficients into a finite number of possible values. The quantization process may reduce the bit depth associated with some or all of the coefficients. For example, an n-bit value may be rounded down to an m-bit value during quantization, where n is greater than m. In some embodiments, external boundary conditions are used to produce modified one or more transform coefficients. For example, a lower range or value may be used in determining if a transform coefficient is given a nonzero value or just zeroed out. As should be appreciated, quantization is a lossy operation and the loss by quantization generally cannot be recovered.

The quantized coefficients may then be entropy coded by an entropy coding module 120, resulting in the final compression bits. The specific steps performed by the entropy coding module 120 will be discussed below in more detail.

To facilitate temporal and spatial prediction, the encoder 116 may also take the quantized transform coefficients E and dequantize them with a dequantizer module 122 resulting in the dequantized transform coefficients E′. The dequantized transform coefficients are then inverse transformed by an inverse transform module 124, resulting in the reconstructed residual PU, e′. The reconstructed residual PU, e′, is then added to the corresponding prediction, x′, either spatial or temporal, to form a reconstructed PU, x”.

Referring still to FIG. 4A, a deblocking filter (DBF) operation may be performed on the reconstructed PU, x″, first to reduce blocking artifacts. A sample adaptive offset (SAO) process may be conditionally performed after the completion of the deblocking filter process for the decoded picture, which compensates the pixel value offset between reconstructed pixels and original pixels. In some embodiments, both the DBF operation and SAO process are implemented by adaptive loop filter functions, which may be performed conditionally by a loop filter module 126 over the reconstructed PU. In some embodiments, the adaptive loop filter functions minimize the coding distortion between the input and output pictures. In some embodiments, loop filter module 126 operates during an inter-picture prediction loop. If the reconstructed pictures are reference pictures, they may be stored in a reference buffer 128 for future temporal prediction.

HEVC specifies two loop filters that are applied in order with the de-blocking filter (DBF) applied first and the sample adaptive offset (SAO) filter applied afterwards. The DBF is similar to the one used by H.264/MPEG-4 AVC but with a simpler design and better support for parallel processing. In HEVC the DBF only applies to an 8×8 sample grid while with H.264/MPEG-4 AVC the DBF applies to a 4×4 sample grid. DBF uses an 8×8 sample grid since it causes no noticeable degradation and significantly improves parallel processing because the DBF no longer causes cascading interactions with other operations. Another change is that HEVC only allows for three DBF strengths of 0 to 2. HEVC also requires that the DBF first apply horizontal filtering for vertical edges to the picture and only after that does it apply vertical filtering for horizontal edges to the picture. This allows for multiple parallel threads to be used for the DBF.

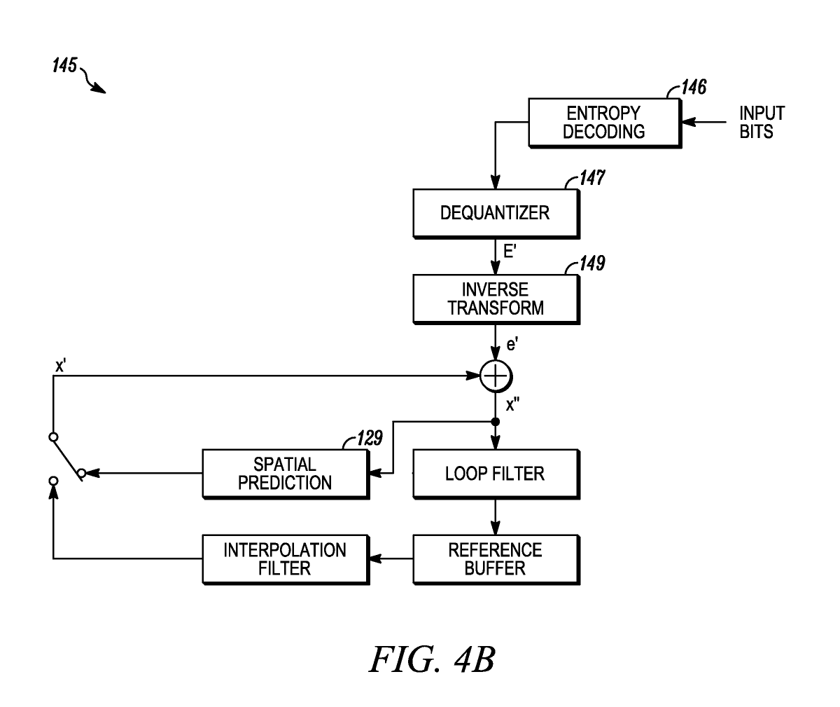

The SAO filter process is applied after the DBF and is made to allow for better reconstruction of the original signal amplitudes by using e.g., a look up table that includes some parameters that are based on a histogram analysis made by the encoder. The SAO filter has two basic types which are the edge offset (EO) type and the band offset (BO) type. One of the SAO types can be applied per coding tree block (CTB). The edge offset (EO) type has four sub-types corresponding to processing along four possible directions (e.g., horizontal, vertical, 135 degree, and 45 degree). For a given EO sub-type, the edge offset (EO) processing operates by comparing the value of a pixel to two of its neighbors using one of four different gradient patterns. An offset is applied to pixels in each of the four gradient patterns. For pixel values that are not in one of the gradient patterns, no offset is applied. The band offset (BO) processing is based directly on the sample amplitude which is split into 32 bands. An offset is applied to pixels in 16 of the 32 bands, where a group of 16 bands corresponds to a BO sub-type. The SAO filter process was designed to reduce distortion compared to the original signal by adding an offset to sample values. It can increase edge sharpness and reduce ringing and impulse artifacts. Further detail on the SAO process will be discussed below with reference to FIGS. 6-10.

In an embodiment of the disclosure, intra pictures (such as an I picture) and inter pictures (such as P pictures or B pictures) are supported by the encoder 116 (FIG. 1A). An intra picture may be coded without referring to other pictures. Hence, spatial prediction may be used for a CU/PU inside an intra picture. An intra picture provides a possible point where decoding can begin. On the other hand, an inter picture generally aims for high compression. Inter picture supports both intra and inter prediction. A CU/PU in inter picture is either spatially or temporally predictive coded. Temporal references are the previously coded intra or inter pictures.

The operation of the entropy coding module 120 (FIG. 4A) according to an embodiment will now be described in more detail. The entropy coding module 120 takes the quantized matrix of coefficients received from the quantizer module 118 and uses it to generate a sign matrix that represents the signs of all of the quantized coefficients and to generate a significance map. A significance map may be a matrix in which each element specifies the position(s) of the non-zero quantized coefficient(s) within the quantized coefficient matrix. Specifically, given a quantized 2D transformed matrix, if the value of a quantized coefficient at a position (y, x) is non-zero, it may be considered as significant and a “1” is assigned for the position (y, x) in the associated significance map. Otherwise, a “0” is assigned to the position (y, x) in the significance map.

Once the entropy coding module 120 has created the significance map, it may code the significance map. In one embodiment, this is accomplished by using a context-based adaptive binary arithmetic coding (CABAC) technique. In doing so, the entropy coding module 120 scans the significance map along a scanning line and, for each entry in the significance map, the coding module chooses a context model for that entry. The entropy coding module 120 then codes the entry based on the chosen context model. That is, each entry is assigned a probability based on the context model (the mathematical probability model) being used. The probabilities are accumulated until the entire significance map has been encoded.

The value output by the entropy coding module 120 as well as the entropy encoded signs, significance map and non-zero coefficients may be inserted into the bitstream by the encoder 116 (FIG. 1A). This bitstream may be sent to the decoders 138 and 140 over the HFC network 122.

It should be noted that the prediction, transform, and quantization described above may be performed for any block of video data, e.g., to a PU and/or TU of a CU, or to a macroblock, depending on the specified coding standard.

When the decoders 138 and 140 (FIG. 1A) receive the bitstream, they perform the functions shown in e.g., FIG. 4B. An entropy decoding module 146 of the decoder 145 may decode the sign values, significance map and non-zero coefficients to recreate the quantized and transformed coefficients. In decoding the significance map, the entropy decoding module 146 may perform the reverse of the procedure described in conjunction with the entropy coding module 120—decoding the significance map along a scanning pattern made up of scanning lines. The entropy decoding module 146 then may provide the coefficients to a dequantizer module 147, which dequantizes the matrix of coefficients, resulting in E′. The dequantizer module 147 may provide the dequantized coefficients to an inverse transform module 149. The inverse transform module 149 may perform an inverse transform operation on the coefficients resulting in e′. Filtering and spatial prediction may be applied in a manner described in conjunction with FIG. 4A.

### Sample Adaptive Offset (SAO)

In an SAO process, an offset is added to each pixel to reduce the distortion of the reconstructed pixel relative to the original pixel. In one embodiment, for a partition in a luma or chroma component, an encoder categorizes the pixels into one of six possible types (both types and sub-types are collectively referred to as types here): four edges offset (EO) types E0, E1, E2, E3 and two band offset (BO) types B0, B1. For the EO types, the pixels are further sub-categorized into one of five possible sub-classes based upon local behavior along the EO type direction. These five sub-classes are described in further detail below. For the BO types, the pixels are further sub-categorized into one of sixteen possible sub-classes based upon intensity. In some embodiments, for a given sub-class of pixels within an SAO type, the same offset is applied. For example, if the offset for sub-class i is oᵢ, then the SAO output corresponding to an input of pᵢ will be pᵢ+oᵢ. The encoder typically selects the SAO type per sub-class to minimize a cost function. For example, if the distortion for a given type t and set of offsets o_{t,i} is D_{t,i} and the corresponding bitrate is R_{t,i}, then the cost function can be J_{t,i}=D_{t,i}+lambda*R_{t,i}, where lambda is a weighting factor. The encoder may signal to the decoder the SAO type per partition and the corresponding offsets per sub-class, and the decoder may perform the classification for the SAO type and applies the offsets per sub-class to each pixel. The SAO type can be signaled per color component, or a given type can be signaled and used for more than one color component. In some embodiments, it is also possible for the encoder to not use or turn off SAO, and this can also be signaled to the decoder.

Coding of SAO type

For coding of SAO type, there are generally two coding methods: high efficiency (HE) and low complexity (LC). In LC, variable length codewords (VLCs) or binarized codewords are assigned to the SAO types; while in HE, the binarized codeword typically assigned to the type is followed by context-based adaptive binary arithmetic coding (CABAC). For the HE case, an encoder may signal the SAO type using a unary code, for example (0's and 1's can be interchanged) as shown in Table 1:

TABLE 1

| SAO type | Code |
|---|---|
| Off | 0 |
| E0 | 10 |
| E1 | 110 |
| E2 | 1110 |
| E3 | 11110 |
| B0 | 111110 |
| B1 | 1111110 |

In Table 1, when SAO type is Off, no SAO is applied and the corresponding codeword is 0. The other codewords correspond to the other EO and BO types.

It may be noted that the units or digits within a codeword may be referred to as “bits” for LC and “bins” for HE. The difference in terminology is a result of applying CABAC to the codeword in the HE method. As used herein, “units” includes both bins and bits in codewords.

### Band Offsets

### Modifications to BO Types and Sub-Classes

Currently, SAO uses two fixed band types, B0 and B1, covering the entire intensity range, with each band further dividing the respective intensity range into 16 equal sub-classes. An offset can be signaled for each of the sub-classes. Because the statistics of a given picture may not fall nicely into one of the two existing band types, B0 and B1, it may be preferable to combine or merge the bands. In some embodiments, one band type can be used, where the range of values to apply an offset can be specified, and a number of sub-classes for the range can be specified, e.g., using a uniform sub-partitioning. An example of such partitioning using a single band type is illustrated in FIG. 6. In some embodiments, the range of values define the one or more sub-classes.

In some embodiments, the range of values where the offset is applied can be determined based on the data and on rate-distortion considerations. The offsets may generally be applied to values where the distortion can be reduced.

In some embodiments, SAO selection type need not be performed, such as when there is a single band type and no other SAO type. In such instances, the single band type is used without the additional steps associated with SAO selection.

As shown in FIG. 6, the start of the band is specified by bₛ, and Nₛ sub-classes of width wₛ can be used. FIG. 6 shows one embodiment where four (Nₛ=4) sub-classes of equal width (wₛ) adjoining each other, where the first sub-class starts at bₛ. In this case, four offsets can be signaled to the decoder for the four sub-classes. In one example, if the last sub-class exceeds the maximum intensity range, the last sub-class can end at the maximum value or wrap around to zero. Additional discussion on BO sub-classes can be found in U.S. patent application Ser. No. 13/672,476, entitled “Devices and Methods for Sample Adaptive Offset Coding and/or Signaling,” filed on Nov. 8, 2012, and U.S. patent application Ser. No. 13/672,484, entitled “Devices and Methods for Sample Adaptive Offset Coding and/or Signaling,” filed on Nov. 8, 2012, incorporated herein by reference in their entirety.

In some embodiments, bₛ is transmitted from the encoder to the decoder. In some embodiments, Nₛ is transmitted from the encoder to the decoder. In some embodiments, wₛ is transmitted from the encoder to the decoder.

Alternatively, a fixed set of values of bₛ, Nₛ and/or wₛ can be specified and agreed upon at the encoder and/or decoder. In such embodiments, only some parameters (e.g., the unspecified values) may need to be transmitted from the encoder to decoder. For example, these parameters can be signaled to the decoder and can be determined for e.g., per partition, LCU, slice (or other unit), picture, group of pictures, sequence, etc.

The specified values need not be transmitted to the decoder, assuming that both encoder and decoder are using the same unit. As used herein, a unit refers to data that both the encoder and decoder have and are configured to derive SAO parameters from. For example, a unit may refer to an LCU, slice, picture, etc. The unit may be specified implicitly (e.g., fixed, slice-dependent, prediction list-based, etc.) or explicitly (e.g., in sequence or slice header, etc.). In such instances, the range of reconstructed values can be determined after the unit is encoded or decoded, and the BO type may be derived from this range.

In some embodiments, the unit can be signaled from the encoder to the decoder, or derived from other coding parameters. Examples of the unit can include an LCU, slice, picture, or group of pictures.

For each BO type, the set of values for which SAO is applied can be determined from the unit or a portion of the unit. For example, the set of values can be determined from a subset of samples in the unit, e.g. alternating samples, the first quarter LCU pixel samples (e.g., top left quarter of the unit), the four corner and center samples of the unit, pixel samples that are not affected by the deblocking filter, etc.

It has been discovered that because natural images tend to exhibit high spatial correlation, a smaller unit may tend to have a smaller dynamic range of intensity values, thereby requiring fewer sub-classes or offsets. In other words, an SAO unit size may be selected that is suitable for typical data, which yields good performance given the number of offsets applied, without requiring too much buffer, delay, etc. In order to strike a balance between coding efficiency, parallel processing, delay, buffering, etc., an LCU unit in the range of 16×16 to 128×128 may be generally suitable for one or more processes described herein.

For example, in some embodiments, the encoder and decoder can decode an LCU and determine the range of values [min, max] in the LCU. A BO type (or types) can then be defined based on the range of values [min, max]. That is, the range of values [bₛ, eₛ] in FIG. 6 for a BO type can be derived based on [min, max], with bₛ denoting the start of the BO type and eₛ denoting the end of the BO type. In one example, the values can be chosen to be bₛ=min and eₛ=max. Once bₛ and eₛ are determined, the band can be divided into Nₛ sub-classes (note that Nₛ can be different for different BO types), for example, Nₛ sub-classes of equal width wₛ. The number of sub-classes Nₛ or width wₛ may be agreed upon at the encoder and decoder, as described above, or it can be transmitted for the LCU, at LCU level, slice level picture level, etc. for one or more color planes.

### Multiple Bands

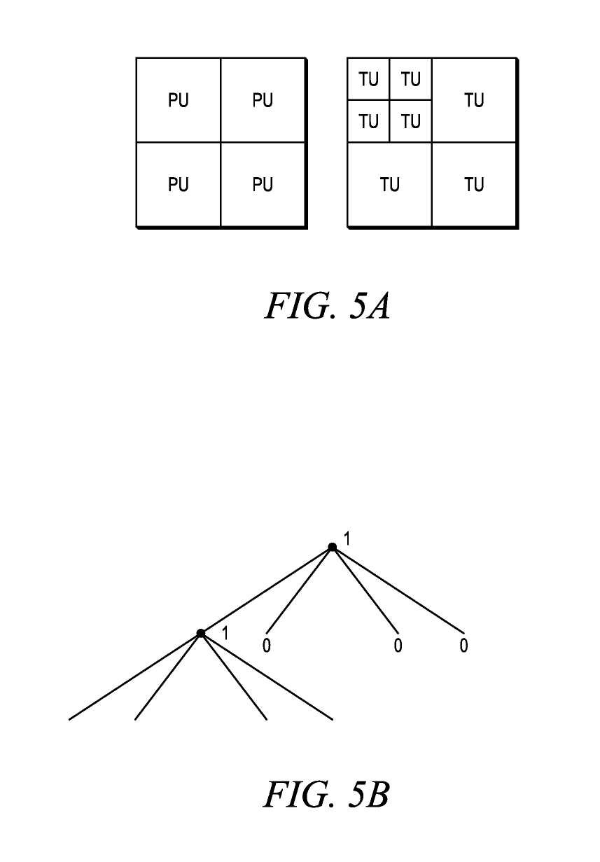

More generally, one or more BO types can be defined based on [min, max] and/or other statistical features of pixels within a corresponding area. For example, they can be defined based upon the statistical distribution of values within the range, such as illustrated in FIG. 7, which plots a distribution (e.g., histogram) of values. In FIG. 7, bₛ=min and eₛ<max, so that no offset is applied to values larger than eₛ. Four BO types are defined by B₀, B₁, B₂, and B₃ (in general BO types can cover overlapping or non-overlapping pixel values.). For each type Bᵢ, Nᵢ sub-classes can be defined by uniform or non-uniform partitioning of the Bᵢ range. For the case of B₁, the sub-classes can be distributed among the two intervals shown. The additional information about the BO types and sub-classes shown in FIG. 7 can either be transmitted to the decoder or agreed upon the encoder and decoder. Alternatively, they can be derived (and not transmitted) based upon statistical properties of the values, such as the mean, variance, etc.

In some embodiments, for a set of values specified by the range [min, max], the bₛ and eₛ values can be obtained from the minimum and maximum values in the subset of samples. Alternatively, in some embodiments, the bₛ and eₛ values may be determined based on a function or transformation of the samples. For example, a transformation such as a DCT can be used, and bₛ and eₛ can be derived from the transformed values, e.g. DC coefficient, AC coefficient, etc. More generally, bₛ and eₛ, or the range of values for the BO type, can be derived from samples wᵢ and vᵢ, for example bₛ=f(w₀, w₁, . . . , wₙ) and eₛ=g(v₀, v₁, . . . , vₘ), where f(wᵢ) and g(vᵢ) are functions of the values wᵢ and vᵢ. The values wᵢ and vᵢ can be, for example, DCT coefficients. By determining the range of values based on a smaller subset of values in the unit, less computation may be required.

In some embodiments, other statistics of the values in a unit can be used to specify a BO type. For example, the mean of the values may be used to specify the location of sub-class intervals for a BO type. In some embodiments, the mean may be computed on a subset of values within the unit (e.g., LCU) and the subset of values can be in a certain region in the unit, alternating samples (or every n^{th} sample horizontally and mth sample vertically), etc. A benefit of computing the mean value is that only one addition per pixel is performed in the subset of unit (e.g., LCU) and a division operation, or if the number of samples is 2ⁿ, a shift of the final total by n bits. For example, if the number of samples over which the mean (average) value is computed is a power of two, then the division by that number can be achieved by a bit shift, which can require less computation than a general division operation.

Once the mean value is computed or obtained, a BO type and/or set of sub-classes can then be derived based on the mean value. For example, a number of sub-classes can be specified relative to the mean value. The sub-classes can be centered or shifted about the mean and can cover a limited range or extended to cover the entire range (e.g., by extending the range of the first and last sub-classes as explained in further detail below).

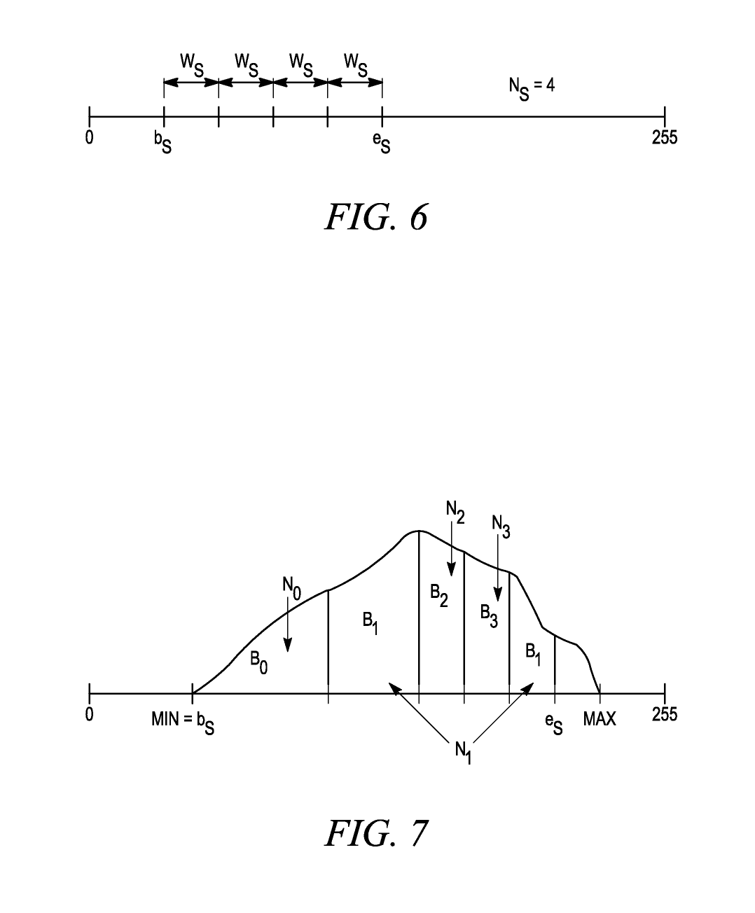

FIG. 8 shows an example where a BO type is specified using the mean value (m) and a width (wₛ) for a case of 4 sub-classes with extended first and last sub-classes. For the case of only one sub-class (one offset) with a limited range or span, the mean can be the center (or approximately the center) of that span. For more sub-classes, the mean can indicate the center (or approximately the center) of all sub-classes. In another example, the entire range may be divided into fixed intervals. For the case of one sub-class, the sub-class can be defined as the interval in which the mean value is located. For additional sub-classes, adjacent intervals can be chosen, for example, centered about the interval with the mean value.

In some embodiments, it may be preferable to perform operations by shift, e.g., by mapping a pixel value to a band index. This mapping may be achieved using a look-up table or by other means (e.g., binary-shift of pixels values). In an example, if the 0-255 pixel range is divided into 32 uniformly spaced bands (corresponding to 32 offsets), then each pixel value may be shifted by 3 binary positions to the right to get the band-index. As is known, the band-index is useful is determining which offset should be applied to each pixel.

In other words, to categorize a pixel value into a sub-class to determine what offset should be applied, one can perform a simple bit shift operation and the result can be used to index the offset value. Merging can be used to combine bins to share a given number of offsets. Consequently, in some embodiments, a combination of pixel value shift and merging offsets may be used to map pixel values in non-uniform and/or discontinuous situations. In such instances, for example, the finest granularity of offset-intervals may be defined by shift and they may then be merged based on min-max or some other conditions to include only N contiguous offset. In one example, 4 offsets are transmitted, to be applied to 4 regions which are not necessarily uniform or contiguous. Each region may be formed by merging uniform bands on a finer granularity (in the finest granularity, there are 32 uniformly spaced bands). Based on statistics (e.g., min-max) or instructions, the 4 offsets are duplicated to some of the finer-uniform bands and assigned an offset of zero to the rest of finer-uniform bands. By this approach, the pixel values may be shifted to find the offset without the need to send all offsets at finest granularity precision (e.g., in this example transmitting 4 offsets instead of 32 offsets). It should be appreciated, for the case of only one sub-class (N=1), there is no need to calculate min and max and only the offset needs to be transmitted.

By determining the set of values for the BO type based on the unit or portion of the unit, the BO type parameters need not be transmitted, thereby saving on overhead bits. In some embodiments, the BO parameters for a current unit can be determined based on a unit previously available to the encoder and decoder. Using previously available unit parameters may reduce latency so that SAO processing can begin on the first sample in the unit without needing to process the unit to determine the BO type parameters. In one example, a collocated unit or motion-compensated unit from a previously coded picture can be used to determine the BO parameters for a current unit.

### No Offset for Empty Sub-Classes

In some embodiments, for the existing B0 and B1 band offset types and/or for a single merged band offset type, there may be many sub-classes with no pixels in the respective intensity range (e.g., also known as empty sub-classes). Although it is possible to encode these sub-classes with a zero offset, in some embodiments, only the offset values for those sub-classes that have pixel intensity values are encoded and signaled. Such encoding of sub-classes that have pixel intensity values may be achieved by additionally encoding an escape code or end-of-offset code to signal no more offset values. This escape code can be, for example, a value that is larger than the maximum offset value used. This approach can be beneficial when there are many empty sub-classes; however, in cases where there are not many empty sub-classes, a combination of only encoding sub-classes having intensity pixel values and encoding sub-classes with a zero offset may be implemented. The approach can be used for signaling of offsets in both band offset and edge offset types. For the case of edge offset types, an empty sub-class corresponds to the case where there are no pixels with the respective gradient pattern. Additional discussion on offset for empty sub-classes can be found in U.S. patent application Ser. Nos. 13/672,476 and 13/672,484, previously incorporated by reference in their entirety.

As is appreciated, in one embodiment the decoder receives information on a band offset specification type such as shown in FIG. 6. The decoder classifies the reconstructed pixel values into the sub-classes according to their intensities. When the decoder receives the sequences of offset values, it can assign the offsets to each sub-class according to where pixel intensities exist in the sub-class.

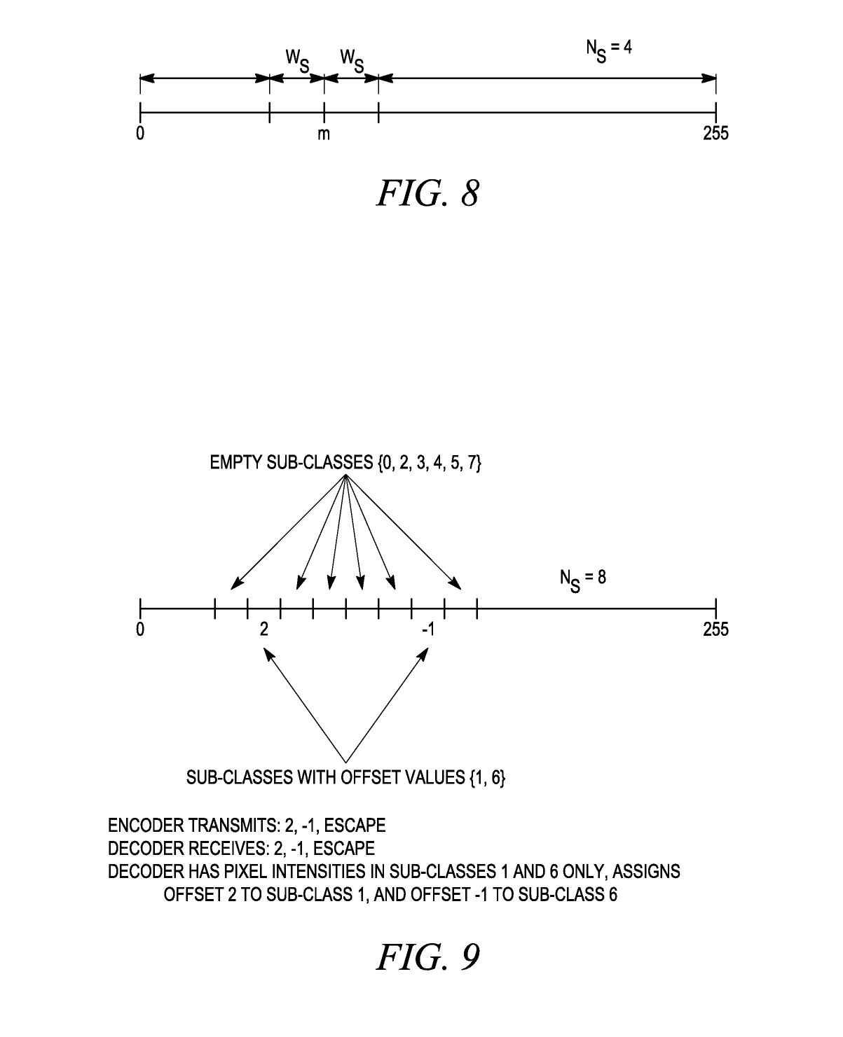

In some embodiments, sub-classes where there are no pixel intensities will have no offset signaled. FIG. 9 illustrates this as an example. FIG. 9 shows an example of BO with eight sub-classes 0-7. The locations of the eight sub-classes or range of pixel amplitudes can be signaled to the decoder using methods previously described. In the example, there are only pixel intensities in sub-classes 1 and 6, while there are no pixel intensities in sub-classes 0, 2, 3, 4, 5, and 7. The latter sub-classes are empty and so no offsets need to be signaled. The offset value of 2 for sub-class 1 and value of −1 for sub-class 6 can be signaled, followed by an optional escape value signaling no more offset values. If the escape value is not signaled, then it is assumed that the decoder performs pixel classification into sub-classes prior to parsing the offset values. After the decoder receives the information specifying the BO sub-classes using methods such as previously described, it can classify the pixel intensities. After classifying the pixel intensities, the decoder assigns the first offset value of 2 to the first non-empty sub-class of 1 and the second offset value of −1 to the second non-empty sub-class of 6.

### Extensions of Sub-Classes

Referring back to FIG. 6, a BO type is specified by bₛ, eₛ, and Nₛ (e.g. Nₛ=4), which represent the start of the BO, end of the BO, and the number of sub-classes, respectively. The values for bₛ and eₛ can be determined from min and max, respectively, e.g. bₛ=min and eₛ=max. The interval can then be partitioned into sub-classes. FIG. 6 shows the sub-classes of equal intervals, although this need not be the case.

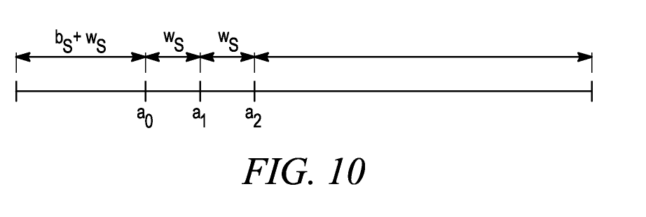

In FIG. 6, no offset is transmitted or applied for values outside the range from bₛ to eₛ. However, values may occur outside the range if bₛ and eₛ are determined from a subset of samples in the unit, while the offset is applied to all the samples in the unit or to samples outside the subset. In such instances, it may be beneficial to apply an offset (e.g., non-zero) to these values outside the range. FIG. 10 illustrates a method for applying an offset to values outside the bₛ and eₛ ranges, where the first and last sub-classes are extended to the smallest and largest possible values (e.g. 0 and 255, respectively). This is one example of non-uniform interval BO sub-classes, and other examples are possible. The offsets for each sub-class can be determined based on e.g., RD optimization of a subset of samples or for all the samples in the unit.

In addition to possible RD performance improvements with the proposed approach, the complexity of SAO BO can be reduced. In FIG. 6, it may be necessary to check whether a pixel value is inside the BO offset range or not. On the other hand, in the scheme illustrated in FIG. 10, the additional out of range checks are not needed.

This is because, in some embodiments, the first and last sub-classes in a BO type can be extended to cover more pixel values with the potential to increase coding efficiency and/or reduce complexity. For example, in one embodiment, the “first” boundary (after 0) can be specified as b_s+w_s, and the “last” boundary (before 255) can be specified as e_s−w_s, with N_s−2 intervals in between.

For example, in one implementation, the band offset oᵢ corresponding to FIG. 10 for 4 sub-classes can be applied to a pixel value p with the following logic statement, where a₀, a₁, and a₂ represent the three boundaries, and a₀=bₛ+wₛ, a₁=bₛ+2wₛ, and a₂=bₛ+3wₛ:

if (p < a₀)

apply offset o₀

else if (p < a₁)

apply offset o₁

else if (p < a₂)

apply offset o₂

else

apply offset o₃

In this case of 4 sub-class BO, at most 3 comparison operations are needed, as opposed to the 5 operations corresponding to a scheme represented in FIG. 6. Because the comparisons are generally performed per pixel, the reduction in operations/time can be significant. For the case of 2 sub-class BO, only 1 comparison operation is needed as opposed to 3 operations, and the operations may be reduced by 67% to a single comparison per pixel. This is because without the sub-class extension, 3 comparison operations are needed, whereas with the extension, only 1 comparison operation is needed.

The modifications described herein may allow for less overhead, computation, and latency for specification and processing using SAO BO. Note that the BO can be specified and applied to any or all color components, and the number of offsets can be different for each color component. For example, luma BO may have 4 offsets and chroma BO may have 2 offsets.

It should also be appreciated that the SAO band types and offsets described herein can be signaled at a partition, LCU, slice, picture, group of pictures, or sequence level. They can also be combined with EO types and offsets signaled at the partition, LCU, slice, picture, group of pictures, or sequence level.

The above description of the disclosed embodiments is provided to enable any person skilled in the art to make or use the disclosure. Various modifications to these embodiments will be readily apparent to those skilled in the art, and the generic principles described herein can be applied to other embodiments without departing from the spirit or scope of the disclosure. Thus, it is to be understood that the description and drawings presented herein represent exemplary embodiments of the disclosure and are therefore representative of the subject matter which is broadly contemplated by the present disclosure. It is further understood that the scope of the present disclosure fully encompasses other embodiments and that the scope of the present disclosure is accordingly limited by nothing other than the appended claims.

What is claimed is:

1. A method for encoding sample adaptive offset (SAO) values in a video encoding process comprising:
selecting a band offset type;
determining a range of values associated with the selected band offset type, the range of values not being transmitted during encoding;
generating one or more offset values for the selected band offset type; and
optionally applying an offset value to at least a current pixel value to form an SAO compensated value.

2. The method of claim 1, wherein the range of values is determined based on a subset of pixel values in a unit.

3. The method of claim 2, wherein the subset of pixels in a unit is selected from the group consisting of: alternating samples, single quarter pixel samples, and corner and center samples of the unit.

4. The method of claim 1, wherein the band offset type is defined by the determined range of values.

5. The method of claim 1, wherein the range of values is specified by a start value and an end value.

6. The method of claim 1, wherein the range of values is partitioned into a number of sub-classes.

7. The method of claim 6, wherein the range of values is partitioned uniformly into a number of sub-classes, each sub-class having an equal width.

8. The method of claim 1, wherein the range of values determined by the video coding system is based in part on data in a video block.

9. The method of claim 8, wherein the range of values is based in part on rate-distortion considerations.

10. The method of claim 8, wherein the range of values is determined from a maximum value and a minimum value derived from data in the video block.

11. The method of claim 10, wherein the range of values is a statistical distribution of values within the range determined from the minimum value and maximum value.

12. The method of claim 11, wherein the minimum value and maximum value is derived from a function or transformation of data in the video block.

13. The method of claim 11, wherein the minimum value and maximum value is derived from the mean value of data in the video block.

14. The method of claim 13, further comprising:
determining one or more sub-classes for at least one band offset type, wherein the number of sub-classes is specified relative to the mean value.

15. The method of claim 14, wherein the one or more sub-classes are centered or shifted about the mean value.

16. The method of claim 1, wherein the band offset type includes a portion of the band defined by the range of values and a portion of the band on either edge of the range of values, wherein the offset value is applied to all portions of the band.

17. The method of claim 16, wherein the range of values is specified by a start value and an end value and wherein the offset value applied to the band that is proximate to the start value, but not included in the range of values, is the same offset applied to the range of values at the start value.

18. The method of claim 16, wherein the range of values is specified by a start value and an end value and wherein the offset value applied to the band that is proximate to the end value, but not included in the range of values, is the same offset applied to the range of values at the end value.

19. The method of claim 1, further comprising:
partitioning video data into blocks, wherein each of the blocks is equal to or smaller than a picture;
applying SAO compensation to each of the pixels in a processed video block.

20. The method of claim 1, wherein the method is implemented on a computer having a processor and a memory coupled to said processor, wherein at least some of steps are performed using said processor.

21. An apparatus configured to encode sample adaptive offset (SAO) values in a video coding process, the apparatus comprising:
a video encoder configured to:
partition video data into blocks, wherein each of the blocks is equal to or smaller than a picture;
select a band offset type;
determine a range of values associated with the selected band offset type, the range of values not being transmitted during encoding;
generate one or more offset values for the selected band offset type; and
apply the offset value to at least a current pixel value to form an SAO compensated value.

22. A method for decoding sample adaptive offset (SAO) values in a video decoding process comprising:
(a) obtaining processed video data from a video bitstream;
(b) partitioning the processed video data into blocks, wherein each of the blocks is equal to or smaller than a picture;
(c) deriving an SAO type from the video bitstream for each of the blocks, wherein the SAO type is selected from the group consisting of one or more edge offset (EO) types and one or more band offset (BO) types;
(d) determining an SAO sub-class associated with the BO type, wherein the sub-class is defined by a range of values that is derived from the processed video data, wherein the range of values is not transmitted to the decoding process;
(e) deriving intensity offset from the video bitstream for the sub-class associated with the SAO type; and
(f) applying SAO compensation to each of the pixels in a processed video block, wherein the SAO compensation is based on the intensity offset of step (e).

23. The method of claim 22, wherein the range of values is determined from a maximum value and a minimum value derived from data in the video block.

24. The method of claim 22, wherein the range of values is a statistical distribution of values within the range determined from the minimum value and maximum value.

25. The method of claim 22, wherein the minimum value and maximum value is derived from a function or transformation of data in the video block.

26. The method of claim 22, wherein the minimum value and maximum value is derived from the mean value of data in the video block.

27. The method of claim 22, wherein the band offset type includes a portion of a band defined by the range of values and a portion of the band on either edge of the range of values, wherein the intensity offset is applied to all portions of the band.

28. The method of claim 27, wherein the range of values is specified by a start value and an end value and wherein the intensity offset is applied to the band that is proximate to the start value, but not included in the range of values, is the same offset applied to the range of values at the start value.

29. The method of claim 27, wherein the range of values is specified by a start value and an end value and wherein the intensity offset applied to the band that is proximate to the end value, but not included in the range of values, is the same offset applied to the range of values at the end value.

30. The method of claim 22, wherein the method is implemented on a computer having a processor and a memory coupled to said processor, wherein at least some of steps (a) through (f) are performed using said processor.

31. An apparatus configured to decode sample adaptive offset (SAO) values in a video decoding process, the apparatus comprising:
a video decoder configured to:
partition video data into blocks, wherein each of the blocks is equal to or smaller than a picture;
derive an SAO type from the video bitstream for each of the blocks, wherein the SAO type is selected from the group consisting of one or more edge offset (EO) types and one or more band offset (BO) types;
determine an SAO sub-class associated with the BO type;
derive intensity offset from the video bitstream for the sub-class associated with the BO type, wherein the sub-class is defined by a range of values that is derived from the processed video data, wherein the range of values is not transmitted to the decoding process; and
apply SAO compensation to each of the pixels in a processed video block, wherein the SAO compensation is based on the intensity offset.

32. The apparatus of claim 31, wherein the apparatus comprises at least one of:
an integrated circuit;
a microprocessor; and
a wireless communication device that includes the video decoder.
